(19) United States
(12) Patent Application Publication
(10) Pub. No.: US 2017/0286978 A1
(43) Pub. Date: Oct. 5, 2017

(54) IDENTIFYING TRENDING TOPICS

(71) Applicant: salesforce.com, inc., San Francisco, CA (US)

(72) Inventors: Jayesh Govindarajan, Palo Alto, CA (US); Naren Chittar, San Jose, CA (US)

(21) Appl. No.: 15/085,808

(22) Filed: Mar. 30, 2016

(51) Int. Cl. G06Q 30/02; G06Q 50/00; G06F 17/30

(52) U.S. Cl. CPC G06Q 30/0202; G06F 17/30864; G06F 17/3053; G06Q 30/0276; G06Q 50/01

(57) ABSTRACT

A trend system generates external trend information for different topics that may be related to merchant items offered by a merchant. External trend information is generated based on content items obtained from sources that are separate from the merchant. Periodically the trend system determines an interest growth rate for a topic based on the external trend information. If the interest growth rate determined for the topic is above an interest threshold, the trend system recommends to the merchant starting a campaign related to the topic.

### BACKGROUND

### Field of the Embodiments

Described embodiments pertain in general to topics related to items, and in particular to identifying trending topics.

### Description of the Related Art

Through online systems, such as social networking systems and blogs, certain topics can quickly start trending and become very popular. Online merchants can increase sales by running marketing campaigns for products related to trending topics. However, online merchants typically do not have a way of determining what is trending, for example, in social networking systems. If an online merchant does become aware of a topic that is trending, by the time the merchant becomes aware and starts running marketing campaigns related to the topic, the topic may no longer be trending. As a result, the marketing campaigns will not be successful in generating more business for the merchant.

### SUMMARY

The embodiments described herein provide methods, computer program products, and computer database systems for determining that a topic is trending higher than normal, making a merchant aware of the trending topic, and running marketing campaigns for merchant items related to the topic. In one embodiment, a trend system generates external trend information for different topics that may be related to merchant items offered by a merchant. External trend information is generated based on content items obtained from sources that are separate from the merchant. The content items may be, for example, published articles, RSS feeds, blogs, and social networking information. Each content item is analyzed for topics. If a content item includes a topic, external trend information is stored by the trend system indicating that the topic was included in the content item.

Periodically the trend system determines an interest growth rate for a topic based on the external trend information. The interest growth rate is a measure that indicates whether interest in the topic has grown or declined over a time period compared to a preceding time period. For example, every day the trend system may determine an interest growth rate for the topic, which indicates how much interest in the topic has grown compared to the previous day. If the interest growth rate determined for the topic is above an interest threshold, the trend system determines to recommend to the merchant starting a campaign related to the topic. The interest threshold is determined specifically for the topic and an interest growth rate being above the interest threshold indicates that interest in the topic is growing fast and more than normal.

As an example, the trend system may determine that typically the growth rate of the topic is 5% every day. Based on the typical growth rate, the trend system may set the interest threshold for the topic to be 10%. If a determination is made that today's growth rate for the topic is 50%, the trend system determines that interest in the topic is growing fast and more than normal based on the interest growth rate of 50% being above the interest threshold of 10%. Since interest in the topic is growing fast, the merchant may want to launch a campaign for merchant items related to the topic.

If the trend system determines to recommend launching a campaign related to the topic, the trend system provides a notification to a merchant user associated with the merchant. The merchant user may be, for example, a marketing employee of the merchant. The notification recommends launching a campaign related to the topic because the topic is trending more than normal. The notification also indicates customer users that have indicated interest in the topic and links to one or more content items that may explain why the topic is trending at its current rate. Further, the notification includes an advertisement that may be provided to customer users if the campaign is launched. The advertisement includes merchant items of the merchant related to the topic.

If the merchant user requests to start the campaign, the advertisement is provided to customer users. In one embodiment, the advertisement is transmitted via email to the customer users that have indicated interest in merchant items related to the topic.

Hence, by analyzing content items from sources separate from the merchant, the trend system becomes aware of topics that are trending and which may not yet be trending with the merchant. When the merchant is made aware of a trending topic, the merchant can easily launch a campaign for merchant items related to the topic. Since there is a great deal of user interest in the topic at the time, there is a high likelihood that the campaign will be successful.

The features and advantages described in this summary and the following detailed description are not all-inclusive. Many additional features and advantages will be apparent to one of ordinary skill in the art in view of the drawings, specification, and claims hereof.

### BRIEF DESCRIPTION OF THE DRAWINGS

FIG. 1 is a block diagram of a trend monitoring environment according to one embodiment.

FIG. 2 is a block diagram illustrating components of a trend system according to one embodiment.

FIG. 3 is a flow chart illustrating a process performed by the trend in recommending starting a marketing campaign for a trending topic according to one embodiment.

FIGS. 4A and 4B illustrate an example of a notification provided to a merchant user according to one embodiment.

FIG. 5 is a block diagram illustrating a functional view of a typical computer system for use as one of the entities illustrated in the environment of FIG. 1 according to an embodiment.

The figures depict various embodiments for purposes of illustration only. One skilled in the art will readily recognize from the following discussion that alternative embodiments of the structures and methods illustrated herein may be employed without departing from the principles of the embodiments described herein.

### DETAILED DESCRIPTION

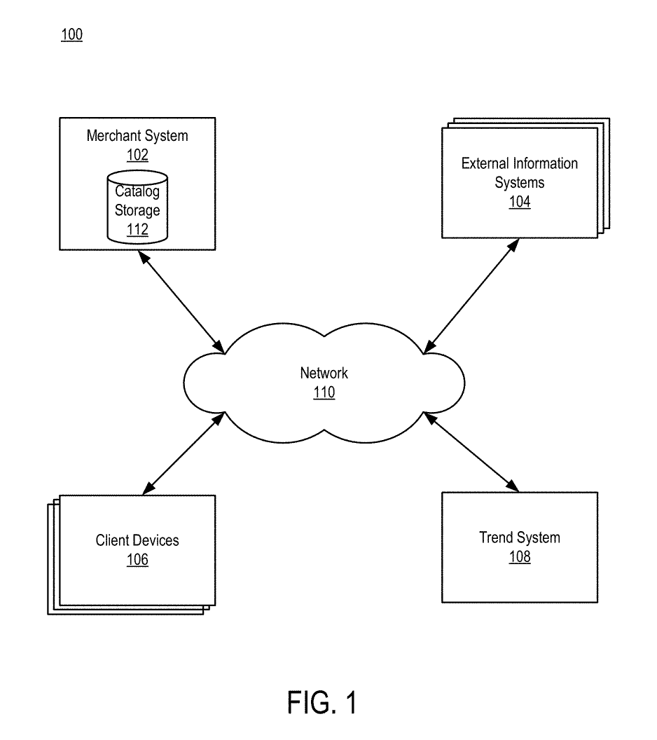

FIG. 1 is a block diagram of a trend monitoring environment 100 according to one embodiment. FIG. 1 illustrates a merchant system 102, multiple external information systems 104, multiple client devices 106, and a trend system 108 connected via a network 110. Although a select number of each entity are shown in FIG. 1, embodiments can have more or less of each entity (e.g., additional external information systems 104 and client device 106).

The merchant system 102 is a computer system through which a merchant offers merchant items to users. The merchant items offered by the merchant system 102 may be tangible items (e.g., clothing, electronics, and furniture) that are shipped to a user after being purchased by the user through the merchant system 102. The merchant items may also be electronic files (e.g., music, video, and movie files) that can be transmitted to a user's client device 106 via the network 110. The merchant items offered by the merchant system 102 may be available for users to purchase or may be offered at no cost.

The merchant system 102 includes a catalog storage 112 that stores information associated with merchant items offered through the merchant system 102. For each merchant item, the catalog storage 112 may store information that includes a description of the merchant item, a maker of the item, a price at which the item is offered, user feedback regarding the item (e.g., user reviews), and other characteristics associated with the item. In one embodiment, the merchant system 102 provides to user's client devices 106 pages that include merchant item information from the catalog storage 112. A page may be, for example, a web page or a page of a mobile application.

If a user provides a search query for a merchant item, the merchant system 102 searches the catalog storage 112 for items that match the search query. The merchant system 102 generates and provides to the user's client device 106 search results that include merchant items that match the search query. If the user selects a merchant item, the merchant system 102 provides to the client device 106 information from the catalog storage 112 that is associated with the merchant item.

If the user requests a merchant item (e.g., requests to purchase the merchant item), the merchant system 102 communicates with the user's client device 106 to allow the user to be able to obtain the item. For example, the user may add the merchant item to an electronic shopping cart. When the user requests to purchase the item in the shopping cart, the merchant system 102 requests payment information from the user. The merchant system 102 completes the purchase of the merchant item based on the payment information.

External information systems 104 are computer systems that provide access to content items. The external information systems 104 are separate from the merchant system 102 (e.g., operated by entities different than the merchant of the merchant system 102). An external information system 104 may be, for example, a system of a social networking service, an article publisher, a blog site, etc. The external information systems 104 host content items and provide content items to entities that request the content items. A content item may be, for example, a published article, a blog post, an RSS feed, and social networking information (e.g., content shared by a user of a social networking service with other users).

A client device 106 is a device used by a user to communicate with the entities connected to the network 110. A client device 106 may be, for example, a personal computer, smart phone, tablet computer, or personal digital assistant (PDA). Through a client device 106 a customer user may communicate with the merchant system 102 to obtain information regarding merchant items. A customer user is a user that has previously obtained merchant items (e.g., previously purchased merchant items) through the merchant system 102 or may obtain merchant items in the future.

In one embodiment, through a client device 106 a merchant user communicates with the trend system 108. A merchant user is associated with the merchant (e.g., an employee, owner, or contractor of the merchant) and can make decisions on behalf of the merchant with regards to marketing campaigns. Through a client device 106 a merchant user receives notifications provided by the trend system 108. A notification received from the trend system 108 may indicate a topic for which there is higher interest than normal. The merchant user can transmit a request to the trend system 108 through the client device 106 requesting that a marketing campaign be initiated related to the topic.

The trend system 108 is a computer system that generates external trend information for topics. A topic is one or more words that may be related with an item. External trend information of a topic is in indicator of interest in the topic. External trend information is generated based on information obtained from the external information systems 104.

For each topic, the trend system 108 maintains an interest threshold. Additionally, for each topic, the trend system 108 periodically determines an interest growth rate based on external trend information associated with the topic. The interest growth rate is a measure that indicates whether interest in the topic has grown or declined over a time period compared to a preceding time period.

If the interest growth rate determined for a topic is above the interest threshold associated with the topic, the trend system 108 determines to recommend to the merchant starting a marketing campaign related to the topic. The interest growth rate being above the interest threshold indicates that interest in the topic is currently growing fast and more than normal.

If the trend system 108 determines to recommend starting a marketing campaign, the trend system 108 provides to a merchant user a notification indicating that the topic is trending with interest in the topic growing fast and more than normal. The notification inquires as to whether the merchant user would like to start a marketing campaign related to the topic. If the merchant user requests to start a marketing campaign related to the topic, the trend system 108 provides an advertisement to customer users that have expressed interests in the topic. The advertisement includes merchant items offered by the merchant that are related to the topic.

In one embodiment, the merchant system 102 and the trend system 108 are operated by different entities. For example, the merchant may be a client of the entity operating the trend system 108. In other embodiments, the merchant system 102 and the trend system 108 are operated by the same entity (e.g., the merchant).

The network 110 represents the communication pathways between the merchant system 102, the external information system 104, client devices 106, and trend systems 108. In one embodiment, the network 110 is the Internet and uses standard communications technologies and/or protocols. Thus, the network 110 can include links using technologies such as Ethernet, 802.11, worldwide interoperability for microwave access (WiMAX), 3G, Long Term Evolution (LTE), digital subscriber line (DSL), asynchronous transfer mode (ATM), InfiniBand, PCI Express Advanced Switching, etc. Similarly, the networking protocols used on the network 110 can include multiprotocol label switching (MPLS), the transmission control protocol/Internet protocol (TCP/IP), the User Datagram Protocol (UDP), the hypertext transport protocol (HTTP), the simple mail transfer protocol (SMTP), the file transfer protocol (FTP), etc.

The data exchanged over the network 110 can be represented using technologies and/or formats including the hypertext markup language (HTML), the extensible markup language (XML), etc. In addition, all or some of links can be encrypted using conventional encryption technologies such as secure sockets layer (SSL), transport layer security (TLS), virtual private networks (VPNs), Internet Protocol security (IPsec), etc. In another embodiment, the entities can use custom and/or dedicated data communications technologies instead of, or in addition to, the ones described above.

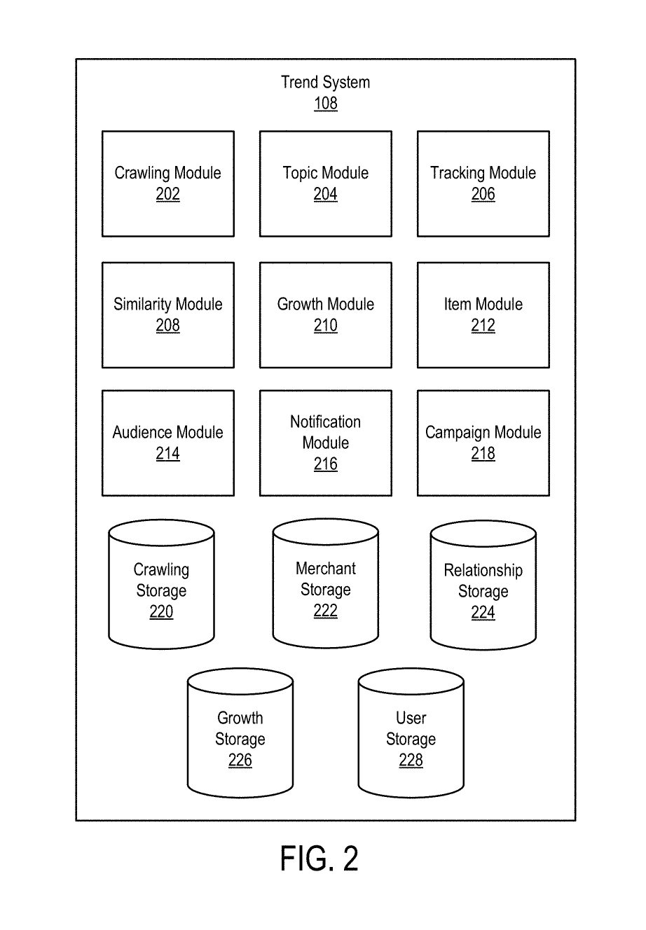

FIG. 2 is a block diagram illustrating components of the trend system 108 according to one embodiment. Those of skill in the art will recognize that other embodiments can have different and/or other components than the ones described here, and that the functionalities can be distributed among the components in a different manner.

A crawling module 202 communicates with the external information system 104 to obtain content items hosted by the external information systems 104. As described above, a content item may be a published article, a blog post, an RSS feed, or social networking information (e.g., content shared by users of a social networking service). The crawling module 202 periodically (e.g., once a day or every hour) communicates with the external information system 104 to determine whether new content items are available. If new content items have been made available by an external information system 104, the crawling module 202 obtains the new content items from the external information system 104.

For each content item obtained from an external information system 104, the crawling module 202 associates timing information with the content item. The timing information may be, for example, the time and date when the content item was made available by the external information system 104 (e.g., when content item was published by the system 104) or the time and date when the content item was obtained by the crawling module 202 from the external information system 104.

A topic module 204 identifies topics included in information obtained from the external information systems 104 and the merchant system 102. When the crawling module 202 obtains a content item from an external information system 104, the topic module 204 analyzes the content item to identify topics included in the content item. To identify the topics included in the content item, the topic module 204 classifies the content item under a category. For example, the potential categories under which a content item may be categorized include, fashion, sports, home décor, music, gaming, etc. In one embodiment, the topic module 204 uses a machine learning model to classify the content item. For each potential category, the machine learning model is trained by providing the model example content items that fall under the category and examples that do not fall under the category.

The topic module 204 identifies a topic list associated with the category under which the content item has been classified. The topic list includes multiple topics associated with the category. For example, if the category is fashion, the fashion topic list may include as topics: poke dot blouse, leather boots, and flannel shirt. The topic module 204 searches the content item for the topics included in the topic list.

Additionally, the topic module 204 searches the topic content item for topics associated with the category that are not included in the topic list. To search for these topics, the topic module 204 performs natural language processing on the content item. In one embodiment, the natural language processing includes the topic module 204 searching for one or more words that meet specific criteria. For example, the topic module 204 may search the content item for an adjective that is followed by a noun, such as “floral blouse.” In one embodiment, the criteria used by the topic module 204 to search for topics depends on the classification of the content item. For example, for fashion content items, the topic module 204 may search for an adjective followed by a noun, but for sports content items, the topic module 204 may search for a verb followed by a noun (e.g., running back).

The topic module 204 updates an external trend index stored in the crawling storage 220 based on the topics identified in the content item and the timing information associated with the content item. The external trend index indicates for each topic, content items analyzed by the topic module 204 over time that have included the topic.

As an example, for each topic the external trend index may include an identifier of each content item the topic has been found in and the time and date associated with each content item. Hence, when the topic module 204 identifies a topic in a content item being analyzed, the topic module 204 updates the external trend index for the topic to include an identifier of the content item and timing information associated with the content item.

The information stored by the external trend index is referred to as external trend information since it indicates the interest there has been for different topics. The more popular a topic is, the more it will appear in content items (e.g., published articles). Based on the external trend information stored in the index, a plot can be generated for each topic that shows the appearances of the topic in content items over time.

In one embodiment, when the topic module 204 identifies a topic in a content item and updates the external trend index for the topic to include an identifier of the content item and timing information associated with the content item, the topic module 204 also includes popularity information associated with the content item. The popularity information indicates how popular the content item has been among users. The popularity information may include, for example, the number of times the content item has been viewed by users, the number of times users have commented regarding the content item, the number of times users have indicated that they like the content item, and the number of times users have indicated that they dislike the content item. In one embodiment, the popularity information is included in the content item.

The topic module 204 also analyzes the merchant item information stored by the merchant system 102 in the catalog storage 112. As described above, for each merchant item offered by the merchant, the catalog storage 112 includes information associated with the item (e.g., brand, model, and description of the merchant item). For each merchant item, the topic module 204 obtains from the merchant system 102 information associated with the item. The topic module 204 analyzes the associated information to identify topics included in the information. Similar to the analysis of the content items, for a merchant item, the topic module 204 categorizes the item and identifies topics included in the associated information using a topic list and natural language processing.

The topic module 204 updates an item index stored in the merchant storage 222 based on the topics identified for the merchant item. In one embodiment, for each merchant item, the page index includes an identifier associated with the item and a list of the topics identified by the topic module 204 for the item based on the associated information.

A tracking module 206 tracks user interactions with the merchant system 102. The tracking module 206 receives from merchant system 102 and/or client devices 106 information indicating interactions performed by customer users with the merchant system 102 with regards to merchant items. An interaction may be, for example, a customer user viewing information associated with a merchant item through the merchant system 102, a customer user viewing a merchant system page that includes a merchant item, a customer user searching for a merchant item, a merchant item being included in search results provided to a customer user, a customer user requesting a merchant item, a customer user adding a merchant item to an electronic shopping cart, and a customer user purchasing a merchant item.

When the tracking module 206 receives information on a user interaction with the merchant system 102 related to a merchant item, the tracking module 206 determines from the information the interaction performed by the user and timing information associated with the interaction (e.g., when the interaction occurred). The tracking module 206 determines the topics associated with the merchant item based on the information stored in the item index of the merchant storage 222.

The tracking module 206 updates a merchant trend index stored in the merchant storage 222 for the topics associated with the merchant item. The merchant trend index includes different topics and for each topic includes information on interactions performed by users with merchant items associated with the topic. For each topic associated with the merchant item, the tracking module 206 identifies the topic in the merchant trend index and includes information indicating the interaction performed and the timing information associated with the interaction.

For example, if a customer user purchased a merchant item associated with the topic “printed pants,” the tracking module 206 will identify “printed pants” in the merchant trend index and include information that the merchant item was purchased on X date and Y time. The information stored by the merchant trend index is referred to as merchant trend information because it indicates interest customer users of the merchant system 102 have had in different topics. The merchant trend information is different than the external trend information stored by the external trend index in that the merchant trend information is specific to the interest of the customer users of the merchant system 102. On the other hand, the external trend information is generated based on information from a variety of sources separate from the merchant system 102. Therefore, the external trend information represents general user interest in topics (doesn't only represent merchant system user interest).

When the tracking module 206 receives information on a user interaction with the merchant system 102 related to a merchant item, the tracking module 206 also attempts to identify the customer user that performed the interaction. In one embodiment, if the customer user is logged in to an account with merchant system 102 when the customer user performs the interaction, the merchant system 102 knows the customer user that performed the interaction and notifies the tracking module 206 of the user that performed the interaction. In one embodiment, if the client device 106 of the customer user includes a cookie that identifies the user, the tracking module 206 determines the customer user that performed the interaction based on the cookie.

If the tracking module 206 is able to identify the customer user that performed the interaction, the tracking module 206 updates user information stored in the user storage 228. The user storage 228 includes for different customer users (e.g., customer user's that have accounts with the merchant system 102) information associated with the customer user, such as contact information (e.g., email address) and other personal information. Further, for each customer user for which information is stored, the user storage 228 also includes information on interactions performed by the user with merchant items and the topics associated with the merchant items.

Hence, when the tracking module 206 is able to identify the customer user that performed the interaction related to the merchant item, the tracking module 206 stores in the user storage 228 for the user the interaction performed (e.g., viewed the merchant item) and the topics associated with the merchant item. The tracking module 206 may also store timing information indicating when the user performed the interaction.

A similarity module 208 determines the relationship between topics. For a topic identified by the topic module 204, the similarity module 208 determines whether the topic is related with other topics identified by the topic module 204. For example, the similarity module 208 may determine that the topic “Daredevil” is related to the topic “X-Men” because both topics frequently appear in same content items since they are both Marvel Comics.

To determine whether a topic is related to another topic, the similarity module 208 calculates a relationship score. In one embodiment, to calculate the relationship score, the similarity module 208 analyze the item index to determine the number of times the two topics were associated with the same merchant item. Additionally, the similarity module 208 analyzes the external trend index to determine the number of times the two topics appeared in the same content item.

The similarity module 208 calculates the relationship score based on the number of times the two topics were associated with the same merchant item and the number of times the two topics appeared in the same content item. Additional factors may also be used in calculating the relationship score, such as the number of times the topics were included in the same page, the number of times the topics were included in the same search query, and the number of times users have viewed a merchant item associated with one topic have also viewed a merchant item associated with the other topic.

If score is above a threshold, the similarity module 208 determines that the two topics are related. If a determination is made that the two topics are related, the similarity module 208 stores information in the relationship storage 224 that indicates that the two topics are related. The relationship storage 224 stores information indicating which topics are related.

A growth module 210 determines whether to recommend starting a marketing campaign related to a topic. For every topic identified by the topic module 204, the growth module 210 periodically determines an interest growth rate for the topic (e.g., once a day or once a week). To determine an interest growth rate for a topic, the growth module 210 determines based on the external trend information stored in the external trend index the number of content items over a time period (e.g., in the past day) that have included the topic. The growth module 210 also determines based on external trend information the number of content items over a preceding time period of the same length (e.g., two days ago) that have included the topic. The growth module 210 calculates the difference between the number of content items of the most recent time period and the number of content items of the preceding time period. The growth module 210 divides the difference by the number of content items of the preceding time period. In one embodiment, the quotient is the interest growth rate. In another embodiment, the quotient is multiplied by one hundred to get the interest growth rate. The interest growth rate indicates whether interest in the topic has grown or declined over the most recent time period compared to the preceding time period.

The growth module 210 stores the calculated growth rate in the growth storage 226. The growth storage 226 includes a history of interest growth rates periodically calculated for each topic. Additionally, the growth module 210 identifies from the growth storage 226 an interest threshold associated with the topic. The growth module 210 compares the interest growth rate calculated for the topic with the associated interest threshold. If the interest growth rate is greater than the interest threshold, the growth module 210 determines to recommend starting a marketing campaign related to the topic.

In one embodiment, for providing the recommendation, the growth module 210 also determines a merchant growth rate for the topic. The merchant growth rate is a measure that indicates whether interest in the topic has grown or declined among customer users with the merchant system 102. The merchant growth rate is specific to the merchant system 102, whereas the interest growth rate represents general user interest since it is determined based on content items obtained from the external information system 104.

To determine the merchant growth rate for the topic, the growth module 210 determines the number of interactions involving the topic over the time period (e.g., in the past day) based on the merchant trend information stored in the merchant trend index of the merchant storage 222. The time period is the same as the time period used in calculating the interest growth rate. The growth module 210 also determines based on merchant trend information the number of interactions involving the topic over the preceding time period (e.g., two days ago). Similar to the interest growth rate, the growth module 210 calculates the difference between the number of interactions of the most recent time period and the number of interactions of the preceding time period. The growth module 210 divides the difference by the number of interactions of the preceding time period. In one embodiment, the quotient is the merchant growth rate. In another embodiment, the quotient is multiplied by one hundred to get the merchant growth rate. As described below with reference to the notification module 216, the interest growth rate and the merchant growth rate are used in recommending starting the marketing campaign.

In one embodiment, the growth module 210 periodically determines the interest threshold for each topic (e.g., once every two months). To determine the interest threshold for a topic, the growth module 210 identifies in the growth storage 226 the interest growth rates calculated for the topic over a period of time (e.g., the growth rates calculated in the past two months). The growth module 210 calculates the average of the identified interest growth rates. In one embodiment, the growth module 210 excludes from the calculation interest growth rates that are outliers (e.g., a rate that is a lot higher than the other interest growth rates). The growth module 210 sums the calculated average with a certain value to obtain the interest threshold for the topic. In one embodiment, the value is set by a system administrator. In another embodiment, the value is a specific percentage of the calculated average.

An item module 212 identifies merchant items to advertise. When the growth module 210 determines to recommend starting a marketing campaign related to a topic, the item module 212 identifies merchant items that can be advertised as part of the marketing campaign. The item module 212 searches the item index of the merchant storage 222 for merchant items associated with the topic. From the identified merchant items, the item module 212 selects a set number of merchant items (e.g., three merchant items). In one embodiment, to select the set number of merchant items, the item module 212 determines for each identified merchant item the number of interactions with the merchant item over a period of time based on the merchant trend information stored in the merchant trend index of the merchant storage 222. The item module 212 selects from the identified merchant items, the set number of merchant items that have had the most interactions.

In one embodiment, the item module 212 also identifies related merchant items to advertise as part of the marketing campaign. The related merchant items may not be associated with the topic but are associated with a related topic. Based on the information stored in the relationship storage 224, the item module 212 determines other topics related to the topic for the marketing campaign. For each related topic, the item module 212 searches the item index of the merchant storage 222 for merchant items associated with the related topic. From the related merchant items identified for the related topics, the item module 212 selects a set number of related merchant items having the most number of interactions. As described below with reference to the notification module 216, the merchant items selected by the item module 212 are used in recommending starting the marketing campaign.

An audience module 214 determines users to target with a marketing campaign. When the growth module 210 determines to recommend starting a marketing campaign related to a topic, the audience module 214 identifies customer users to target with the marketing campaign based on the customer users having shown interest in the topic. Customer users that have shown interest in the topic are more likely to be interested in the marketing campaign.

To identify the customer users, the audience module 214 searches the user storage 228 for customer users that have interacted with one or more merchant items associated with the topic. The customer users identified based on the search are users that can be targeted with the marketing campaign.

In one embodiment, the audience module 214 also identifies customer users that have not already been identified but have interacted with merchant items associated with related topics. These types of customer users can be identified in order to expand the audience for the marketing campaign. To identify the customer users, the audience module 214 determines topics related to the topic of the marketing campaign. For each related topic, the searches the user storage 228 for customer users that have interacted with one or more merchant items associated with the related topic and have not already been identified. As described below with reference to the notification module 216, the identified users are used in recommending starting the marketing campaign.

The notification module 216 recommends to a merchant user starting a marketing campaign. When the growth module 210 determines to recommend starting a marketing campaign related to a topic, the notification module 216 creates a notification with the recommendation. The notification may be, for example, an email, a text message, a direct message, or instant message.

The notification indicates that interest in the topic is growing fast and more than normal. The notification module 216 includes in the notification the interest growth rate determined by the growth module 210 that is above the corresponding interest threshold. In one embodiment, the notification module 216 also includes in the notification the merchant growth rate determined by the growth module 210. The notification module 216 also determines the number of customer users identified by the audience module 214 that can be targeted with the marketing campaign. The notification module 216 includes the number in the notification.

Additionally, as part of the notification, the notification module 216 generates an advertisement that can be provided to customer users if the marketing campaign is launched. The advertisement includes the merchant items selected by the item module 212 that are associated with the topic and the merchant items selected by the item module 212 that are associated with related topics. The notification module 216 includes the advertisement with the notification.

In one embodiment, the notification module 216 selects a content item that may explain the increased interest in the topic. To select the content item, the notification module 216 searches the external trend information stored by the crawling storage 220 for content items that included the topic and are associated with a time that falls within the time period for which the interest growth rate was determined by the growth module 210. For example, if the interest growth rate was determined for the past twenty four hours, the notification module 216 searches for content items that are associated with timing information that falls within the past twenty four hours and include the topic. From the content items identified based on the search, the notification module 216 selects a content item. In one embodiment, the notification module 216 randomly selects a content item from the identified content items. In another embodiment, the notification module 216 selects a content item based on popularity information associated with the content item. For example, the notification module 216 may select the content item with the most views, comments or likes. The notification module 216 includes in the notification a reference (e.g., a link) to the content item.

The notification module 216 transmits the created notification to a merchant user associated with the merchant. In one embodiment, the notification is transmitted to the merchant user via email. In other embodiments, the notification is transmitted to the merchant user via a phone number or other identifier associated with the merchant user. The merchant user can make decisions on behalf of the merchant with regards to the marketing campaign.

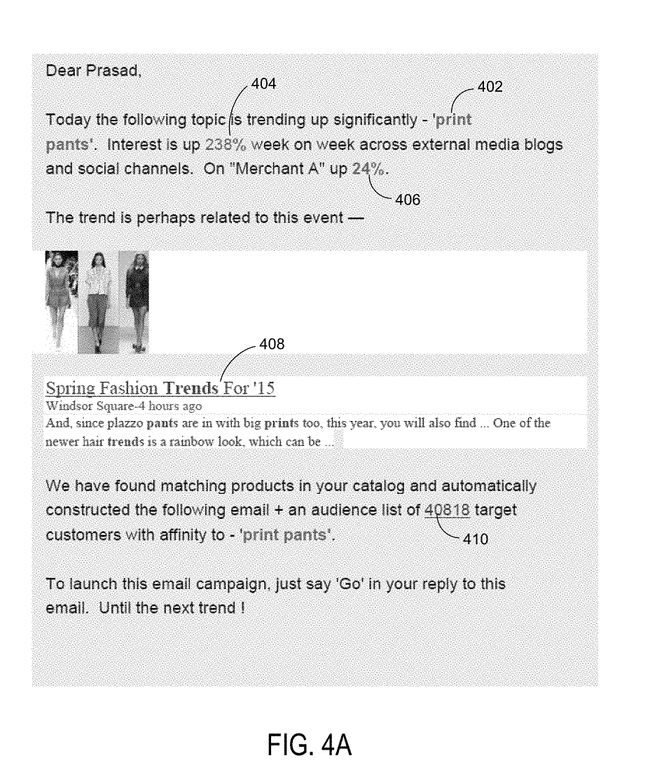

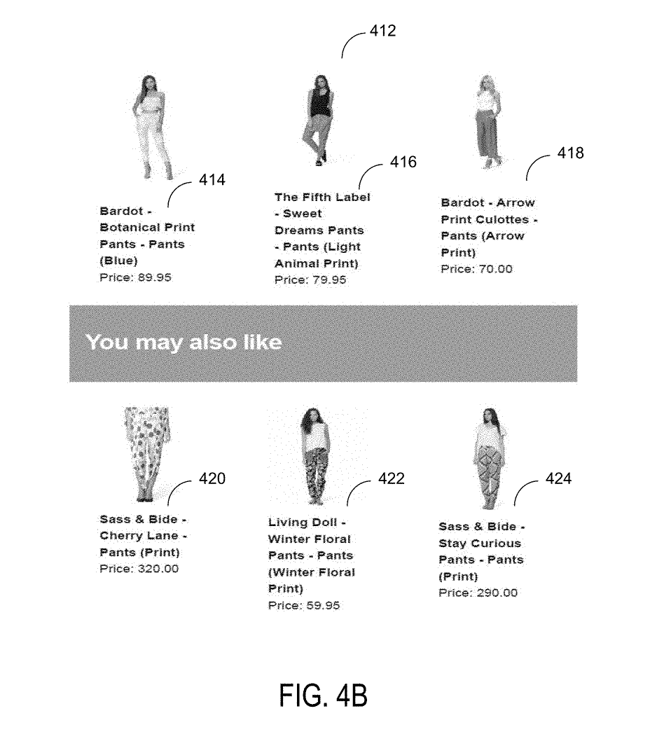

FIGS. 4A and 4B illustrate an example of a notification transmitted to a merchant user. As can be seen in FIG. 4A, the notification indicates that the topic 402 “print pants” is trending high. The notification further includes an interest growth rate 404 of “238%” and a merchant growth rate 406 of “24%.” Since topic 402 is not trending high with the merchant, it would be in the merchant's interest to start a marketing campaign to make customer users aware of merchant items that are associated with the topic 402.

Additionally, the notification includes a link 408 to a content item that may explain the increased interest in the topic 402. The notification also includes a number 410 of customer users that can be targeted with the marketing campaign because they have shown interest in the topic or a related topic.

FIG. 4B illustrates an advertisement 412 included with the notification. The advertisement includes three merchant items 414, 416, and 418 that are associated with the topic and three merchant items 420, 422, and 424 that are associated with related topics. Based on information include in the notification, the merchant user can make an informed decision as to whether to start the marketing campaign.

Returning to FIG. 2, a campaign module 218 executes marketing campaigns. After the notification module 216 recommends to a merchant user starting a marketing campaign related to a topic, if the merchant user requests to start the marketing campaign, the campaign module 218 generates a list with customer users that are to be targeted with the marketing campaign. The list includes the customer users identified by the audience module 214 for the marketing campaign.

In one embodiment, the campaign module 218 filters the list. For example, as part of the request if the merchant user indicated to target customer users that have interacted with merchant items associated with the topic but not target the customer users that have only interacted with merchant items associated with related topics, the campaign module 218 removes from the list the customer users that have only interacted with merchant items associated with related topics. As another example, the campaign module 218 may remove from the list customer users that have been black listed or requested to unsubscribe from marketing campaigns.

In one embodiment, for each customer user remaining in the list, the campaign module 218 obtains from the users storage 228 contact information (e.g., email address) stored for the customer user. The campaign module 218 identifies the advertisement created by the notification module 216 for the campaign and transmits the advertisement to each customer user from the list using the contact information.

In another embodiment, when a customer user from the list interacts with the merchant system 102, the campaign module 218 provides the advertisement to the customer user. For example, the advertisement may be included with content requested by the customer user from the merchant system 102.

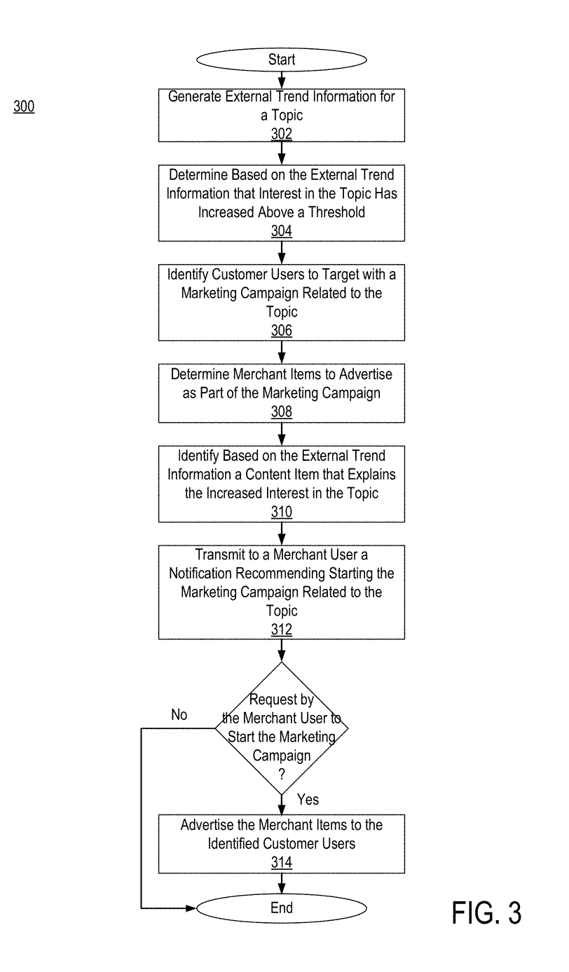

FIG. 3 is a flow chart illustrating a process 300 performed by the trend system 108 in recommending starting a marketing campaign for a trending topic according to one embodiment. Those of skill in the art will recognize that other embodiments can perform the steps of FIG. 3 in different orders. Moreover, other embodiments can include different and/or additional steps than the ones described herein.

The trend system 108 generates 302 external trend information for a topic based on content items obtained from external information systems 104. The trend system 108 determines 304 based on the external trend information that interest in the topic has increased above a threshold. The trend system 108 identifies 306 customer users to target with a marketing campaign related to the topic. The trend system 108 determines 308 merchant items to advertise as part of the marketing campaign. Additionally, the trend system 108 identifies 310 based on the external trend information a content item that explains the increased interest in the topic.

The trend system 108 transmits 312 to a merchant user a notification recommending starting the marketing campaign related to the topic. The notification includes information as to the identified customer users that would be targeted and the determined merchant items that would be advertised as part of the marketing campaign. The notification also includes a link to the content item that explains the increased interest in the topic.

If the merchant user does not request to start the marketing campaign, the process 300 ends. On the other hand, if the user requests to start the marketing campaign, the trend system 108 advertises 314 the merchant items to the identified customer users.

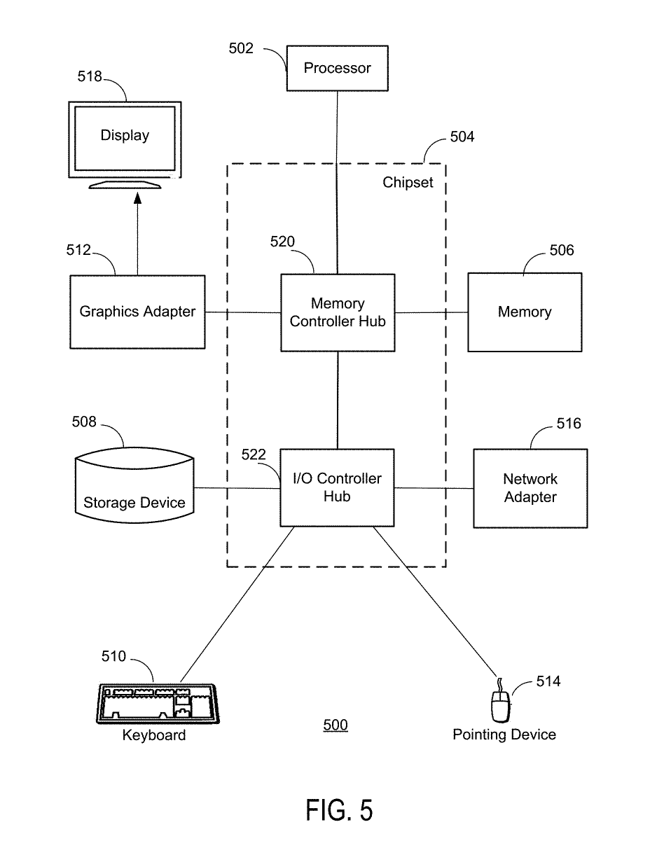

FIG. 5 is a high-level block diagram illustrating a functional view of a typical computer system (may also be referred to as a computer database system) for use as one of the entities illustrated in the environment 100 of FIG. 1 according to an embodiment. Illustrated are at least one processor 502 coupled to a chipset 504. Also coupled to the chipset 504 are a memory 506, a storage device 508, a keyboard 510, a graphics adapter 512, a pointing device 514, and a network adapter 516. A display 518 is coupled to the graphics adapter 512. In one embodiment, the functionality of the chipset 504 is provided by a memory controller hub 520 and an I/O controller hub 522. In another embodiment, the memory 506 is coupled directly to the processor 502 instead of the chipset 504.

The storage device 508 is a non-transitory computer-readable storage medium, such as a hard drive, compact disk read-only memory (CD-ROM), DVD, or a solid-state memory device. The memory 506 holds instructions and data used by the processor 502. The pointing device 514 may be a mouse, track ball, or other type of pointing device, and is used in combination with the keyboard 510 to input data into the computer system 200. The graphics adapter 512 displays images and other information on the display 518. The network adapter 516 couples the computer system 500 to the network 110.

As is known in the art, a computer 500 can have different and/or other components than those shown in FIG. 5. In addition, the computer 500 can lack certain illustrated components. For example, a computer system 500 acting as a trend system 108 may lack a keyboard 510 and a pointing device 514. Moreover, the storage device 508 can be local and/or remote from the computer 500 (such as embodied within a storage area network (SAN)).

The computer 500 is adapted to execute computer modules for providing the functionality described herein. As used herein, the term “module” refers to computer program instruction and other logic for providing a specified functionality. A module can be implemented in hardware, firmware, and/or software. A module can include one or more processes, and/or be provided by only part of a process. A module is typically stored on the storage device 508, loaded into the memory 506, and executed by the processor 502.

The types of computer systems 500 used by the entities of FIG. 1 can vary depending upon the embodiment and the processing power used by the entity. For example, a client device 106 may be a mobile phone with limited processing power, a small display 518, and may lack a pointing device 514. The trend system 108, in contrast, may comprise multiple blade servers working together to provide the functionality described herein.

The particular naming of the components, capitalization of terms, the attributes, data structures, or any other programming or structural aspect is not mandatory or significant, and the mechanisms that implement the embodiments described may have different names, formats, or protocols. Further, the systems may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of above description present features in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times, to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain embodiments described herein include process steps and instructions described in the form of an algorithm. It should be noted that the process steps and instructions of the embodiments could be embodied in software, firmware or hardware, and when embodied in software, could be downloaded to reside on and be operated from different platforms used by real time network operating systems.

The embodiments described also relate to apparatuses for performing the operations herein. An apparatus may be specially constructed for the required purposes, or it may comprise a general-purpose computer selectively activated or reconfigured by a computer program stored on a computer readable medium that can be accessed by the computer. Such a computer program may be stored in a non-transitory computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will be apparent to those of skill in the, along with equivalent variations. In addition, the present embodiments are not described with reference to any particular programming language. It is appreciated that a variety of programming languages may be used to implement the teachings of the embodiments as described herein.

The embodiments are well suited for a wide variety of computer network systems over numerous topologies. Within this field, the configuration and management of large networks comprise storage devices and computers that are communicatively coupled to dissimilar computers and storage devices over a network, such as the Internet.

Finally, it should be noted that the language used in the specification has been principally selected for readability and instructional purposes, and may not have been selected to delineate or circumscribe the inventive subject matter. Accordingly, the disclosure of the embodiments is intended to be illustrative, but not limiting.

1. A computer-implemented method comprising:
generating, by a computer database system, external trend information for a topic based on content items obtained from external information systems separate from a merchant system;
determining, by the computer database system, that interest in the topic has increased above a threshold based on the external trend information;
responsive to determining that interest in the topic has increased above the threshold, recommending, by the computer database system to a merchant user, starting a campaign related to the topic;
responsive to receiving from the merchant user a request to start the campaign related to the topic, starting, by the computer database system, the campaign marketing merchant items related to the topic and offered by the merchant system.

2. The method of claim 1, wherein generating the external trend information comprises:
obtaining the content items from the external information systems;
identifying the topic included in the content items;
storing, for each content item, information indicating that the content item includes the topic and timing information associated with the content item.

3. The method of claim 1, wherein determining that interest in the topic has increased comprises:
determining an interest growth rate for the topic based on the external trend information; and
responsive to the interest growth rate being greater than the threshold, determining that interest in the topic has increased above the threshold.

4. The method of claim 3, wherein determining the interest growth rate for the topic comprises:
determining, based on the external trend information, a first number of content items over a first time period that included the topic;
determining, based on the external trend information, a second number of content items over a second time period that included the topic; and
calculating the interest growth rate based on the first number and the second number.

5. The method of claim 1, further comprising:
identifying a plurality of interest growth rates determined over a time period, each of the plurality of interest growth rates indicating interest in the topic at different times;
calculating an average of the plurality of interest growth rates; and
determining the threshold based on the average of the plurality of interest growth rates.

6. The method of claim 1, further comprising:
determining a first number of interactions by users over a first time period with merchant items associated with the topic, the first number of interactions through the merchant system;
determining a second number of interactions by users over a second time period with merchant items associated with the topic, the second number of interactions through the merchant system;
calculating a merchant growth rate based on the first number of interactions and the second number of interactions; and
including the merchant growth rate in the recommendation to start the campaign.

7. The method of claim 1, further comprising:
identifying merchant items associated with the topic;
selecting, from the identified merchant items, a subset of merchant items based on a number of interactions with each merchant item in the subset of merchant items; and
including information associated with the subset of merchant items in the recommendation to start the campaign.

8. The method of claim 7, wherein the subset of merchant items are marketed to users in response to starting the campaign.

9. The method of claim 1, further comprising:
identifying users that have interacted with merchant items associated with the topic;
including information associated with the identified users in the recommendation to start the campaign; and
targeting the identified users in response to starting the campaign.

10. The method of claim 9, wherein targeting the identified users comprises:
identifying communication information associated with each of the identified users; and
transmitting, to each identified user, a communication using the communication information associated with the identified user, the communication advertising merchant items related to the topic and offered by the merchant system.

11. The method of claim 1, further comprising:
identifying, based on the external trend information, a plurality of content items obtained from external information systems that include the topic, each of the plurality of content items associated with timing information included in a time period for which interest in the topic has increased;
selecting, from the plurality of content items, a content item based on popularity information associated with the selected content item; and
including a reference to the selected content item in the recommendation to start the campaign, the reference included as an explanation for the increased interest in the topic.

12. The method of claim 11, wherein the popularity information includes at least one of: a number of comments received for the selected content item, a number of views of the selected content item, and a number of users that have indicated that they like the selected content item.

13. The method of claim 1, wherein the content items obtained from the external information systems comprise at least one of: a blog post, a published article, and social networking information.

14. A computer-implemented method comprising:
generating, by a computer database system, trend information for a topic based on content items obtained from a plurality of systems;
responsive to determining based on the trend information that interest in the topic has increased, recommending, by the computer database system to a user, starting a campaign related to the topic;
responsive to receiving from the user a request to start the campaign related to the topic, starting, by the computer database system, the campaign marketing items related to the topic.

15. A non-transitory computer-readable storage medium storing computer-executable instructions which when executed by a computer database system cause the computer database system to perform steps comprising:
generating external trend information for a topic based on content items obtained from external information systems separate from a merchant system;
determining that interest in the topic has increased above a threshold based on the external trend information;
responsive to determining that interest in the topic has increased above the threshold, recommending to a merchant user starting a campaign related to the topic;
responsive to receiving from the merchant user a request to start the campaign related to the topic, starting the campaign marketing merchant items related to the topic and offered by the merchant system.

16. The computer-readable storage medium of claim 15, wherein generating the external trend information comprises:
obtaining the content items from the external information systems;
identifying the topic included in the content items;
storing, for each content item, information indicating that the content item includes the topic and timing information associated with the content item.

17. The computer-readable storage medium of claim 15, wherein determining that interest in the topic has increased comprises:
determining an interest growth rate for the topic based on the external trend information; and
responsive to the interest growth rate being greater than the threshold, determining that interest in the topic has increased above the threshold.

18. The computer-readable storage medium of claim 17, wherein determining the interest growth rate for the topic comprises:
determining, based on the external trend information, a first number of content items over a first time period that included the topic;
determining, based on the external trend information, a second number of content items over a second time period that included the topic; and
calculating the interest growth rate based on the first number and the second number.

19. The computer-readable storage medium of claim 15, wherein the computer-executable instructions further cause the computer database system to perform steps comprising:
identifying a plurality of interest growth rates determined over a time period, each of the plurality of interest growth rates indicating interest in the topic at different times;
calculating an average of the plurality of interest growth rates; and
determining the threshold based on the average of the plurality of interest growth rates.

20. The computer-readable storage medium of claim 15, wherein the computer-executable instructions further cause the computer database system to perform steps comprising:
determining a first number of interactions by users over a first time period with merchant items associated with the topic, the first number of interactions through the merchant system;
determining a second number of interactions by users over a second time period with merchant items associated with the topic, the second number of interactions through the merchant system;
calculating a merchant growth rate based on the first number of interactions and the second number of interactions; and
including the merchant growth rate in the recommendation to start the campaign.
